(19) United States
(12) Patent Application Publication
(10) Pub. No.: US 2005/0169972 A1
(43) Pub. Date: Aug. 4, 2005

(54) Product for orally administering a substance

(76) Inventor: Billy Sevki Hasirci, Surbiton (GB)

Correspondence Address: HENRY E. NAYLOR, HENRY E. NAYLOR & ASSOCIATES, P.O.BOX 86080, BATON ROUGE, LA, 70879-6060, US

(21) Appl. No.: 11/049,592

(22) Filed: Feb. 2, 2005

(30) Foreign Application Priority Data
Feb. 3, 2004 (GB) 0402285.1

(51) Int. Cl. A23K 1/165; A23K 1/17

(52) U.S. Cl. 424/442; 426/635

(57) ABSTRACT

A product for orally administering one or more substances to an animal or human. The product comprises two separate parts arranged and/or adapted to fit together to enclose the substance(s). In one embodiment, the separate parts are comprised of a biscuit material, and the parts are fitted together to enclose and conceal the substance(s). The substance(s) nay have therapeutic properties.

### FIELD OF THE INVENTION

The present invention relates to a product for use in orally administering a substance to an animal or human.

### FIELD OF THE INVENTION

It is often difficult to administer a substance to an animal, particularly if the substance has a taste and/or odor and/or form which is regarded as unpalatable. Many medicines and therapeutic substances have unpleasant tastes or odors, and there are often problems administering them to animals in forms such as pills, tablets, capsules, liquids, etc. For example, in the case of pets such as cats and dogs, the animal may refuse to eat and/or swallow a tablet and would resist implanting the tablet in its mouth and would spit it out. Moreover, an animal that is unwell is often particularly reluctant to take oral medication and attempts to force a tablet or pill into its throat may cause it further distress. An added problem is that two persons may be required in attempts to administer medication orally, one person to restrain the animal and the other to administer the medication. The mixing of crushed tablets or other therapeutic substances with the animal's food is also problematical. The smell, taste and/or texture of the added substance is often sensed by the animal and can lead to failure to administer the medicine and also waste of the food in which it is mixed. There can be similar problems in administering medication orally to children and infants.

In the field of pest control by administering noxious substances, similar problems occur. Poisons for pests such as rodents are often sensed by the rodents or are rejected because of their unappealing taste and/or smell and/or texture even when they are mixed with a suitable food used as bait.

Attempts have been described to deal with the foregoing difficulties. U.S. Pat. No. 5,792,470 discloses an edible container for administering medication to an animal, the container comprising a tubular member having a closed end and an open end through which medication may be passed from outside the container to the inside, the open end then being pinched to close and seal it so that the medication is enclosed within the tubular member, the tubular member being formed from an unspecified fibrous material. A drawback of this container is that the container must be supple in order to be closable by pinching the open end, and containers of this type tend to collapse and self-seal when stored, reducing or terminating their utility, and they tend to be generally unstable.

U.S. Pat. No. 5,853,757 discloses an edible sack made from dehydrated meat by-products admixed with a soy flour and water mixture and a glycerine lubricant. A medicament is placed in the sack, and the open end is pinched to close it. In order to pinch the sack closed, it must be supple. There tend to be problems avoiding collapse of the sack and self-sealing, reducing its utility during distribution and storage. Moreover, it must be stored under regulated conditions to maintain its composition (e.g., in terms of water content, etc.).

U.S. Pat. No. 5,674,515 discloses a hollow edible tube of a similar type to those discussed above and which is pinched to seal a medicine therein when in use. The edible tube is subject to the same types of drawbacks as mentioned above.

U.S. Pat. No. 5,411,735 discloses a toroidal ring of edible material arranged to have a tablet retained by wedging or jamming in the central space. The ring could not conceal the odor of a medicine, and must be administered in such a manner that the tablet would not be seen or otherwise apparent, which might not be easy to effect. Moreover, each ring has a size which is suitable for only a very limited range of sizes of tablets. The ring could not be used with liquid or powdered medicines.

U.S. Pat. No. 5,747,063 discloses an edible capsule containing a medicament. The medicament is enclosed within the capsule at the time of manufacture. The user purchases the capsule with the contained medicament and cannot choose which medicament should be in the capsule.

U.S. Pat. No. 4,857,333 discloses a chewable food treat which may be in the form of a bone and which has one or more preformed pockets of depressions in which a tablet is received. This proposal is subject to the same type of drawbacks as those outlined in connection with U.S. Pat. No. 5,747,063.

An object of the present invention is to provide a product for administering a substance which avoids or mitigates one or more of the problems and difficulties mentioned above.

Another object of the invention is to provide a product for administering a substance to an animal or a human which is adaptable for use with substances in a variety of physical forms (e.g., tablet, pill, capsule, liquid, etc.) in a variety of different physical shapes and sizes so that a single form such product (e.g., one size) is suitable for administering many types of substance.

Another object of the present invention is to provide a product for administering two or more substances to an animal or human.

### SUMMARY OF THE INVENTION

The present invention accomplishes these and other objects and provides a product for use in administering one or more substances to an animal or human, the product being defined in claim 1 of the set of claims following this description. The product comprises two separate parts arranged and/or adapted to fit together to enclose the substance(s). Other optional features of the product of the invention are defined in the claims following claim 1 in the said set of claims.

### BRIEF DESCRIPTION OF THE FIGURES

FIG. 1 is a perspective view of a two-part biscuit for an animal pet shown with its two parts separated to receive a medicinal tablet; and

FIG. 2 is another view of the biscuit of FIG. 1 shown with its two parts closed together around the medicinal tablet.

### DETAILED DESCRIPTION OF THE INVENTION

The two parts of the product may fit together by an interference fit and/or by adhesion (e.g., due to an adhesive substance). One part may have a projecting rim arranged to fit within the other part as an interference type of fit. Alternatively or in addition, one or both parts may be adhered to each other. Such adhesion may be effected by providing an adhesive substance on one or both parts at regions which are intended to adhere, e.g., the rims. The adhesive may be provided by moistening the said regions or by providing on one or both regions an adhesive material such as an edible paste. The two parts may be both generally cup-shaped and arranged and/or adapted for their open ends or open tops to fit together. The two separate parts may be comprised of a biscuit material. The two separate parts may comprise one or more flavoring agents and/or one or more odiferous agents and/or suitable coloring material to make them appealing to the animal or human to which the product is to be administered. The separate parts may comprise one or more excipients to impart desirable properties to the product. The excipients may include (inter alia) one or more of the following: strengthening agents to impart physical stability, suitable chemical stabilizing agents, gelatin, glycerine, and/or suitable preservatives and suitable anti-fungal agents. The invention also includes the aforsaid product when containing the substance(s) to be administered. The substance(s) may be in a form selected from one or more of the following: powder, tablet, pill, liquid, gel, one or more capsules which may contain one or more of the foregoing. When the product is intended for therapeutic purposes, the said substance may be a medicine and/or therapeutic agent and/or nutrition-promoting agent such as one or more vitamins and/or a prophylactic agent (inter alia). When the product is intended for use against animal pests, the said substance may be noxious, repellant, or poisonous or a contraceptive (inter alia) or any two or more of the foregoing.

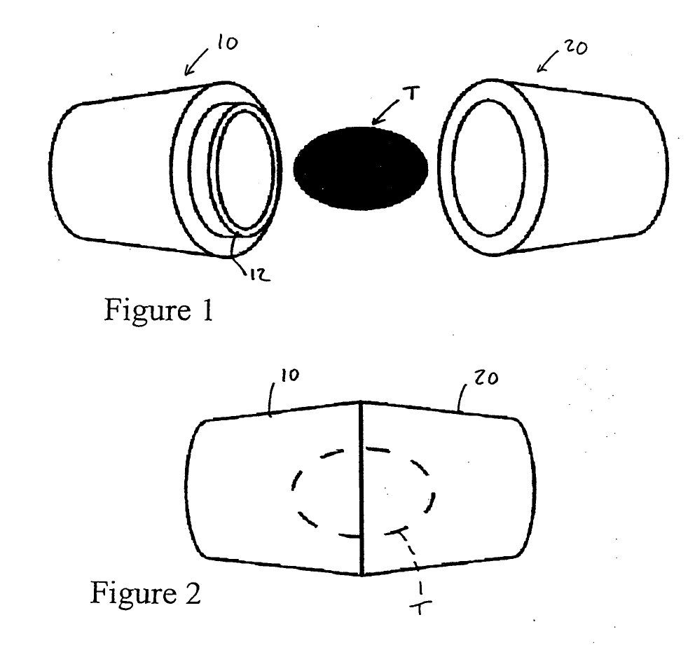

The invention is now further described with reference to an embodiment thereof, given by way of a non-limitative example only, and with reference to the accompanying drawings in which FIG. 1 is a perspective view of a two-part biscuit for an animal pet shown with its two parts separated to receive a medicinal tablet; and FIG. 2 is another view of the biscuit of FIG. 1 shown with its two parts closed together around the medicinal tablet.

Referring to the drawings, there is shown an edible biscuit for a pet animal and which may be suitable for administering medicines and therapeutic substances to a dog or cat, inter alia. The biscuit comprises two hollow parts 10, 20 which are arranged to fit together to enclose a medicinal tablet or pill T. In the embodiment shown, each part of the biscuit is generally cup-shaped and part 10 has an annular, projecting rim 12 around its open end. The rim 12 of part 10 fits closely within the open end of the other part 20 in an interference fit or interference manner so holding the two parts 10,20 together. If desired or appropriate, the rim of one or both parts 10, 20 may be moistened so that the parts adhere to each other. Alternatively or in addition, the rim of one or both parts may be provided with an edible adhesive substance so that the parts adhere to each other. Such substances are well known in the art. The tablet or pill T may be of any desired type to provide the animal with any required medication.

When the tablet or pill T has been enclosed within the biscuit, as shown in FIG. 2, the biscuit may be offered to the animal. The biscuit effectively conceals and disguises the tablet or pill and also conceals or disguises the taste and odor and texture of the tablet or pill. The animal will eat the biscuit with the enclosed tablet or pill, so that the required medication is effectively administered to the animal.

Whilst the biscuit shown in the drawings has been described as intended for consumption by a pet animal, it may also be intended for consumption by other animals (e.g., farm animals and wild animals) or by a human, particularly a child.

The biscuit need not be of circular cross-section as shown in the drawings, and may, if desired, be of other cross-sections, such as oval. The biscuit need not have the generally symmetrical ellipsoid form shown in the drawings, and it may have other forms without departing from the invention.

The biscuit may have a size suitable for use according to the size of the animal for which it is intended and also suitable to accommodate the tablet or pill or other substance to be administered using the biscuit.

1. An edible product for use in orally administering one or more substances to an animal or human, the product comprising two separate parts arranged and adapted to fit together to enclose said one or more substances.

2. The edible product of claim 1 wherein the two parts fit together and are held together by an interference fit or with an adhesive.

3. The edible product of claim 2 wherein one part has a projecting rim arranged to fit within the other part.

4. The edible product of claim 1 wherein the two parts are both generally cup-shaped and wherein their open ends to fit together.

5. The edible product of claim 1 wherein the two parts are each comprised of an edible material.

6. The edible product of claim 5 wherein the edible material is a biscuit material.

7. The edible product of claim 1 wherein the two parts are comprised of one or more components selected from the group consisting of flavoring agents, odiferous agents, and coloring materials.

8. The edible product of claims 1 that contains a substance for animal or human consumption.

9. The edible product of claim 8 wherein the substance is in a form selected from the group consisting of powder, tablet, pill, liquid, and gel.

10. The edible product of claim 8 wherein the substance is one suitable for therapeutic or prophylactic purposes.

11. The edible product of claim 10 wherein the substance is a vitamin.

12. The edible product of claim 1 which contains a substance to control animal pests is is selected from the group consisting of noxious, poisonous, repellant, and contraceptive agents.

13. An edible product for use in orally administering one or more substances to an animal or human, the product comprising two separate parts each having a projecting rim arranged to fit with the other part to enclose said one or more substances, which parts are held together by an interference fit or with an adhesive and which parts are comprised of one or more components selected from the group consisting of flavoring agents, odiferous agents, and coloring materials.

14. The edible product of claim 13 which contains a substance for animal or human consumption.

15. The edible product of claim 14 wherein the substance is in a form selected from the group consisting of powder, tablet, pill, liquid, and gel.

16. The edible product of claim 14 wherein the substance is one suitable for therapeutic or prophylactic purposes.

17. The edible product of claim 16 wherein the substance is a vitamin.

18. The edible product of claim 13 which contains a substance to control animal pests is is selected from the group consisting of noxious, poisonous, repellant, and contraceptive agents.
